(19) United States
(12) Patent Application Publication
(10) Pub. No.: US 2025/0124554 A1
(43) Pub. Date: Apr. 17, 2025

(54) SEAMLESS SWITCHING OF DYNAMIC RANGE AND REFRESH RATE ON DISPLAY DEVICES

(71) Applicants: Yungyu Lin, New Taipei (TW); Wei-Chung Liao, New Taipei City (TW); Melvin Chang, Taipei (TW); Cheng-Han Chiang, New Taipei City (TW); Hsinyu Chen, Taipei (TW); Krishna Kishore Nidamanuri, Bangalore (IN); Wei-Han Hsiao, Taipei (TW); Yuhsuan Lin, Taipei (TW); Cindy Chen, Taipei (TW); Wen-Chi Yu, Taoyuan (TW)

(72) Inventors: Yungyu Lin, New Taipei (TW); Wei-Chung Liao, New Taipei City (TW); Melvin Chang, Taipei (TW); Cheng-Han Chiang, New Taipei City (TW); Hsinyu Chen, Taipei (TW); Krishna Kishore Nidamanuri, Bangalore (IN); Wei-Han Hsiao, Taipei (TW); Yuhsuan Lin, Taipei (TW); Cindy Chen, Taipei (TW); Wen-Chi Yu, Taoyuan (TW)

(21) Appl. No.: 19/000,177

(22) Filed: Dec. 23, 2024

(51) Int. Cl. G06T 5/90

(52) U.S. Cl. CPC G06T 5/90

(57) ABSTRACT

Systems, apparatus, articles of manufacture, and methods are disclosed to implement seamless switching of dynamic range and/or refresh rate on display devices. An example apparatus disclosed herein causes a display to activate panel self refresh after a command to switch a graphics output from a first dynamic range to a second dynamic range, the graphics output provided to the display. The example apparatus also switches the graphics output from the first dynamic range to the second dynamic range after the panel self refresh is activated. The example apparatus further causes the display to deactivate the panel self refresh after the graphics output is switched to the second dynamic range.

### BACKGROUND

Modern compute systems, such as personal computers, notebook computers, tablet computers, etc., may support switching between multiple display dynamic ranges and/or multiple display refresh rates. Some such compute systems may implement a standard dynamic range that supports displaying color with a depth of 8 bits, and a high dynamic range that supports displaying color with a depth of 10-12 bits. Additionally or alternatively, some such compute systems may implement a low display refresh rate, such as 60 Hertz (Hz), and a high refresh rate, such as 120 Hz. Such compute systems may also provide the ability to switch between dynamic ranges and/or refresh rates based on a user input and/or a detected system operating state.

### BRIEF DESCRIPTION OF THE DRAWINGS

FIG. 1 is a block diagram of an example compute system including an example host device and an example display device that implement seamless switching of dynamic range and/or refresh rate in accordance with teaching of this disclosure.

FIG. 2 illustrates an example user interface provided by the system of FIG. 1.

FIG. 3 illustrates an example scenario in which a display device is switched from a standard dynamic range to a high dynamic range without seamless dynamic range switching.

FIG. 4 illustrates an example scenario in which the system of FIG. 1 performs seamless switching of the display device from standard dynamic range to high dynamic range.

FIG. 5 illustrates an example scenario in which the system of FIG. 1 performs seamless switching of the display device from high dynamic range to standard dynamic range.

FIG. 6 illustrates an example sequence diagram depicting example commands and example operations performed by the system of FIG. 1 to implement seamless switching of the display device from one dynamic range to another dynamic range.

FIG. 7 illustrates an example sequence diagram depicting commands and operations used to cause a refresh rate of a display device to be switched without seamless refresh rate switching.

FIG. 8 illustrates an example sequence diagram depicting example commands and example operations performed by the system of FIG. 1 to implement seamless switching of the display device from one refresh rate to another refresh rate.

FIGS. 9-10 are flowcharts representative of example machine-readable instructions and/or example operations that may be executed, instantiated, and/or performed by example programmable circuitry to implement the compute system 100 of FIG. 1.

FIG. 11 is a block diagram of an example processing platform including programmable circuitry structured to execute, instantiate, and/or perform the example machine-readable instructions and/or perform the example operations of FIGS. 9-10 to implement the compute system 100 of FIG. 1.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine-readable instructions of FIGS. 9-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

At least some compute systems, such as personal computers, notebook computers, tablet computers, etc., support switching between multiple display dynamic ranges and/or multiple display refresh rates. In some examples, such compute systems implement a first dynamic range, such as a standard dynamic range, and a second dynamic range, such as a high dynamic range, to display graphics data, such as images, videos, games, etc. For example, the first/standard dynamic range may support displaying graphics data with a color depth of 8 bits (or some other number of bits), and the second/high dynamic range may support displaying color with a larger color depth of 10-12 bits (or some other (e.g., larger) number of bits). In some examples, the compute system consumes more power but produces higher graphics quality when implementing the second/high dynamic range, and consumes less power but produces lower graphics quality when implementing the first/standard dynamic range.

In some examples, such compute systems additionally or alternatively implement a first refresh rate, such as a low refresh rate, and a second refresh rate, such as a high refresh rate, that determines the rate, or frequency, at which the display device updates displayed graphics data. For example, the first/lower refresh rate may support a display update rate of 60 Hz (or some other clock frequency), and the second/higher refresh rate a display update rate of 120 Hz (or some other clock frequency). In some examples, the compute system consumes more power but produces higher graphics quality when implementing the second/high refresh rate, and consumes less power but produces lower graphics quality when implementing the first/low refresh rate.

To support switching between supported dynamic ranges, some compute systems provide a graphical user interface to accept a user input to specify/switch the particular dynamic range (e.g., switch from the first/standard dynamic range to the second/high dynamic range, or vice versa) to be implemented by the compute system at a particular time (e.g., the current time). To support switching between supported refresh rates, some compute systems provide a graphical user interface to accept a user input to enable the refresh rate to be switched dynamically (e.g., change from the first/standard refresh rate to the second/high refresh rate, or vice versa) based on an operating condition of the compute system (e.g., such as whether the compute system is operating under battery power or line power). Some systems support any combination of the above techniques for switching between supported dynamic ranges and/or switching between supported refresh rates. Some systems support either switching between supported dynamic ranges or switching between supported refresh rates, but not both.

However, as described in detail below, some techniques implemented by compute systems to switch between supported dynamic ranges and/or switch between supported refresh rates cause the compute system to display a blank screen, such as a black screen, while the dynamic range and/or the refresh rate is being switched. Displaying a blank screen can interrupt a visual flow of the graphics data being presented by the compute system, which can negatively impact user experience. In contrast, example seamless dynamic range switching techniques disclosed herein enable a compute system to switch between supported dynamic ranges seamlessly (e.g., without presentation of a blank (or black) screen) and, thus, without interrupting the visual flow of the graphics data being presented by the compute system. Likewise, example seamless refresh rate switching techniques disclosed herein enable a compute system to switch between supported refresh rates seamlessly (e.g., without presentation of a blank (or black) screen) and, thus, without interrupting the visual flow of the graphics data being presented by the compute system. As such, example seamless dynamic range switching techniques and example seamless refresh rate switching techniques disclosed herein can improve user experience over other switching techniques. Example techniques for seamless dynamic range switching and seamless refresh rate switching disclosed herein are provided below.

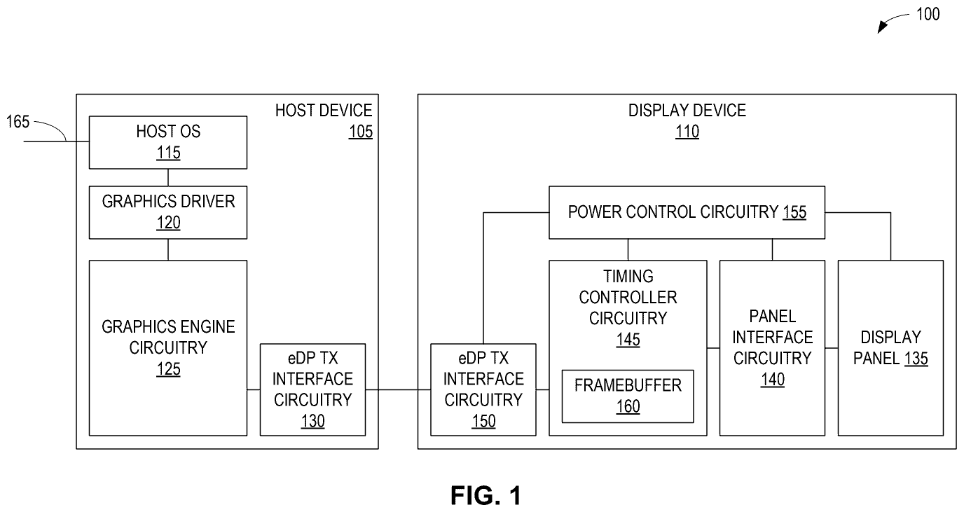

Turning to the figures, FIG. 1 is a block diagram of an example compute system 100 including an example host device 105 and an example display device 110 that implement seamless dynamic range switching and/or seamless refresh rate switching in accordance with teaching of this disclosure. In some examples, at least some of the compute system 100 of FIG. 1 may be instantiated (e.g., creating an instance of, bring into being for any length of time, materialize, implement, etc.) by programmable circuitry such as a Central Processor Unit (CPU) executing first instructions. Additionally or alternatively, at least some of the compute system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

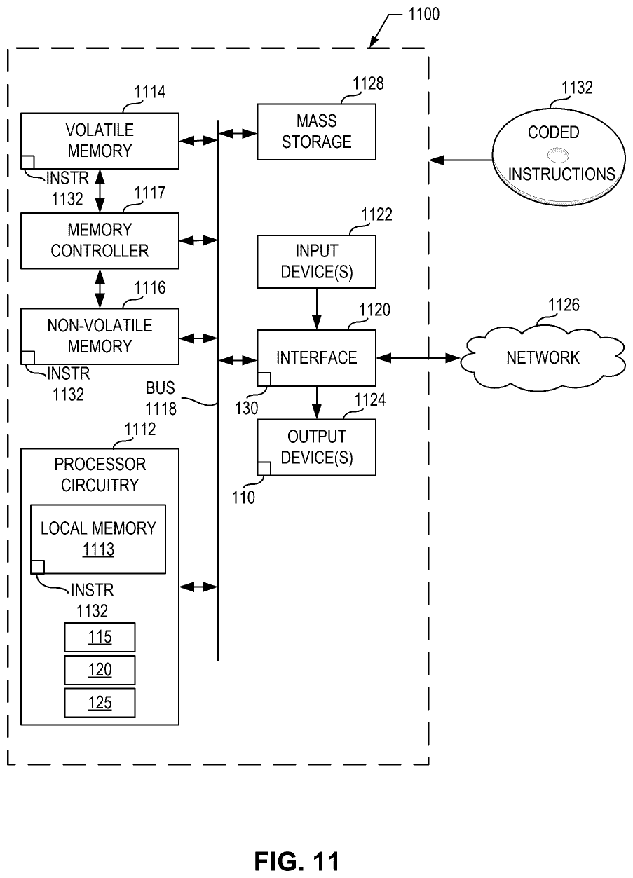

The example compute system 100 of the FIG. 1 can correspond to any type of compute system. For example, the compute system 100 can be a personal computer, a notebook computer, a tablet computer, a server, etc. In some examples, the compute system 100 is implemented by the programmable circuitry platform 1100 of FIG. 11, which is described in detail below.

In the illustrated example, the host device 105 of the compute system 100 includes an example host operating system (OS) 115, an example graphics driver 120, example graphics engine circuitry 125 and example display interface circuitry 130. The example display device 110 (also referred to herein as the example display 110) includes an example display panel 135, example panel interface circuitry 140, example timing controller circuitry 145, example host interface circuitry 150 and example power control circuitry 155. The timing controller circuitry 145, also referred to as the TCON 145, includes an example framebuffer 160.

In the illustrated example, the host device 105 includes graphics engine circuitry 125 to generate a graphics output to be provided to the display device 110 via the display interface circuitry 130. The graphics engine circuitry 125 generates the graphics output based on graphics data and commands provided by the graphics driver 120. For example, based on one or more commands from the graphics driver 120, the graphics engine circuitry 125 uses the graphics data from the graphics driver 120 to generate the graphics output to have standard dynamic range (e.g., an 8-bit color depth) or high dynamic range (e.g., a 10-bit or 12-bit color depth). Also, in the illustrated example, the graphics engine circuitry 125 accepts one or more commands from the graphics driver 120 to switch the dynamic range of the graphics output from a current, first dynamic range to a new, second dynamic range. For example, the graphics engine circuitry 125 accepts command(s) to switch the graphics output from standard dynamic range to high dynamic range, or from high dynamic range to standard dynamic range.

In the illustrated examples, the graphics engine circuitry 125 also generates the graphics output to have a low refresh rate (e.g., a 60 Hz refresh rate) or a high refresh rate (e.g., a 120 Hz refresh rate) based on one or more commands from the graphics driver 120. Furthermore, in the illustrated example, the graphics engine circuitry 125 accepts one or more commands from the graphics driver 120 to switch the refresh rate of the graphics output from a current, first refresh rate to a new, second refresh rate. For example, the graphics engine circuitry 125 accepts command(s) to switch the graphics output from a low refresh rate to a high refresh rate, or from a high refresh rate to a low refresh rate. In some examples, the graphics engine circuitry 125 is implemented by one or more graphics processing units (GPUs), one or more central processing units (CPUs), and/or any other types and/or numbers of processor circuits, or any combination thereof.

The host device 105 includes the graphics driver 120 to interface the host OS 115 with the graphics engine circuitry 125. In the illustrate example, the host OS 115 obtains graphics data from one or more application executing on the host device 105 and provides the graphics data to the graphics driver 120. The graphics driver 120, in turn, provides the graphics data to the graphics engine circuitry 125, which uses the graphics data to generate the graphics output for the display device 110. The graphics driver 120 also provides one or more commands to the graphics engine circuitry 125 to set/switch the dynamic range and/or the refresh rate of the graphics output. In the illustrated example, the graphics driver 120 generates the command(s) to set/switch the dynamic range and/or the refresh rate of the graphics output based on example user input 165.

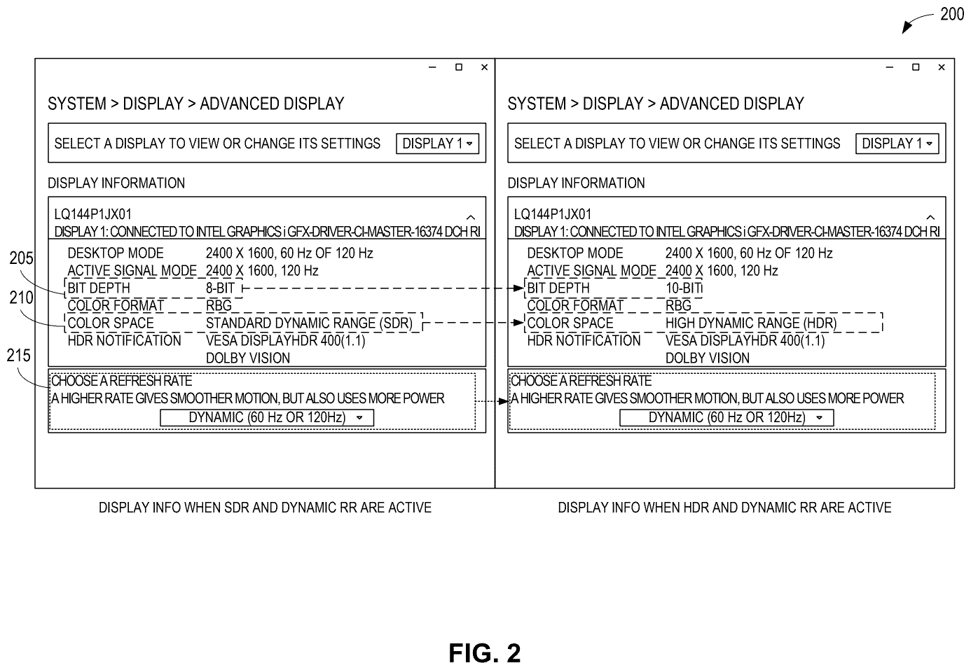

FIG. 2 illustrates an example user interface 200 implemented by the graphics driver 120 of the host device 105 included in the compute system 100 of FIG. 1. The user interface 200 of the illustrated example permits a user to enter the user input 165 that sets/switches the dynamic range of the graphics output provided by the graphics engine circuitry 125. The user interface 200 also permits a user to enter the user input 165 that determines whether the refresh rate of the graphics output provided by the graphics engine circuitry 125 can be changed based on an operating condition of the compute system 100.

For example, the user interface 200 includes example input prompts 205 and 210 to permit a user to set/switch the graphics output from the graphics engine circuitry 125 to have standard dynamic range or high dynamic range. The input prompts 205 and 210 also permit the user to set the particular color bit depth (e.g., if a particular dynamic range supports multiple bit depths). The user interface 200 also includes an example prompt 215 to permit the user to set/switch the graphics output from the graphics engine circuitry 125 to have a low refresh rate (e.g., 60 Hz) or a high refresh rate (e.g., 120 Hz). In the illustrated example, the prompt 215 also permits the user to select that the graphics output from the graphics engine circuitry 125 is to have a dynamic refresh rate that is switched between the low refresh rate (e.g., 60 Hz) and the high refresh rate (e.g., 120 Hz) based on one or more operating conditions of the compute system 100. For example, the dynamic refresh rate setting can cause the graphics driver 120 to switch to the low refresh rate (e.g., 60 Hz) when the compute system 100 is operating under battery power, and switch to the high refresh rate (e.g., 120 Hz) when the compute system 100 is operating under active line power.

Returning to FIG. 1, the host device 105 of the illustrated example includes the display interface circuitry 130 to provide, output or otherwise transmit the graphics output from the graphics engine circuitry 125 to the display device 110. The display interface circuitry 130 also provides, outputs or otherwise transmits one or more commands from the graphics engine circuitry 125 to the display device 110 to control operation of the display device 110. In the illustrated example, the display interface circuitry 130 is implemented by example embedded display port (eDP) transmit (TX) interface circuitry 130. However, in some examples, the display interface circuitry 130 can be implemented by any interface circuitry that supports panel self refresh or similar functionality. Panel self refresh is described in further detail below.

In the illustrated example, the display device 110 of the compute system 100 includes the host interface circuitry 150 to accept, obtain or otherwise receive the graphics output from the graphics engine circuitry 125 of the host device 105. The host interface circuitry 150 also accepts, obtains or otherwise receives one or more commands from the graphics engine circuitry 125 of the host device 105 to control operation of the display device 110. In the illustrated example, the host interface circuitry 150 is implemented by example eDP receive (RX) interface circuitry 150. However, in some examples, the host interface circuitry 150 can be implemented by any interface circuitry that supports panel self refresh or similar functionality. Panel self refresh is described in further detail below.

The display device 110 includes the TCON 145 and the panel interface circuitry 140 to provide the graphics data obtained by the host interface circuitry 150 to the display panel 135. The TCON 145 and the panel interface circuitry 140 also use the command(s) obtained by the host interface circuitry 150 to control operation of the display panel 135 and/or other elements of the display device 110. The display panel 135 of the illustrated example can be implemented by any type(s) and/or number of display panels. For example, the display panel 135 can be implemented by one or more light emitting diode (LED) displays, organic light emitting diode (OLED) displays, a liquid crystal displays (LCDs), a cathode ray tube (CRT) displays, in-place switching (IPS) displays, etc.

In the illustrated example, the display device 110 includes the power control circuitry 155 to provide power to the other circuitry of the display device 110, including the display panel 135, the panel interface circuitry 140, the timing controller circuitry 145 and the host interface circuitry 150. In some examples, the power control circuitry 155 also controls the power states of the display panel 135, the panel interface circuitry 140, the timing controller circuitry 145, and/or the host interface circuitry 150. For example, the power control circuitry 155 may control one or more of the display panel 135, the panel interface circuitry 140, the timing controller circuitry 145, and/or the host interface circuitry 150 to enter a low power state, such as a standby state, a sleep state, an off state, etc., or resume operation in a normal power state, such as an on state, based on one or more commands obtained by the host interface circuitry 150 from the host device 105.

In the illustrated example, the TCON 145 also provides other timing and control signals to the display panel 135, the panel interface circuitry 140, the host interface circuitry 150 and/or the power control circuitry 155. For example, the TCON 145 provides timing and control signals to the display panel 135, the panel interface circuitry 140, the host interface circuitry 150 and/or the power control circuitry 155 to implement panel self refresh based on a frame of data stored in the framebuffer 160. Panel self refresh is a feature specified in the Video Electronics Standards Association (VESA®) eDP standard (e.g., the VESA® eDP Standard Version 1.5, published Oct. 27, 2021). The panel self refresh feature is implemented by the TCON 145 and utilizes the framebuffer 160 to store a full frame image. The panel self refresh feature then uses the TCON 145 to cause the display device 110 to self-update the image displayed on the display panel 135 based on the image stored in the framebuffer 160 when new frame updates are not received from the host device 105. As such, the panel self refresh feature enables power saving in the compute system 100 when the image being displayed on the display panel 135 is static by allowing the TCON 145 to use the image frame stored in the framebuffer 160 to refresh the display panel 135 directly rather than continuously requesting image data from the host device 105.

As disclosed in further detail below, the compute system 100 adapts the panel self refresh feature to cause the display device 110 to display a current image frame stored in the framebuffer 160 rather than displaying a blank screen (e.g., black screen) during a switch of the dynamic range and/or a switch of the refresh rate of the graphics output provided by the host device 105 to the display device 110. In this way, switching the dynamic range and/or the refresh rate of the graphics output is seamless to a user of the compute system 100, and provides a good visual experience.

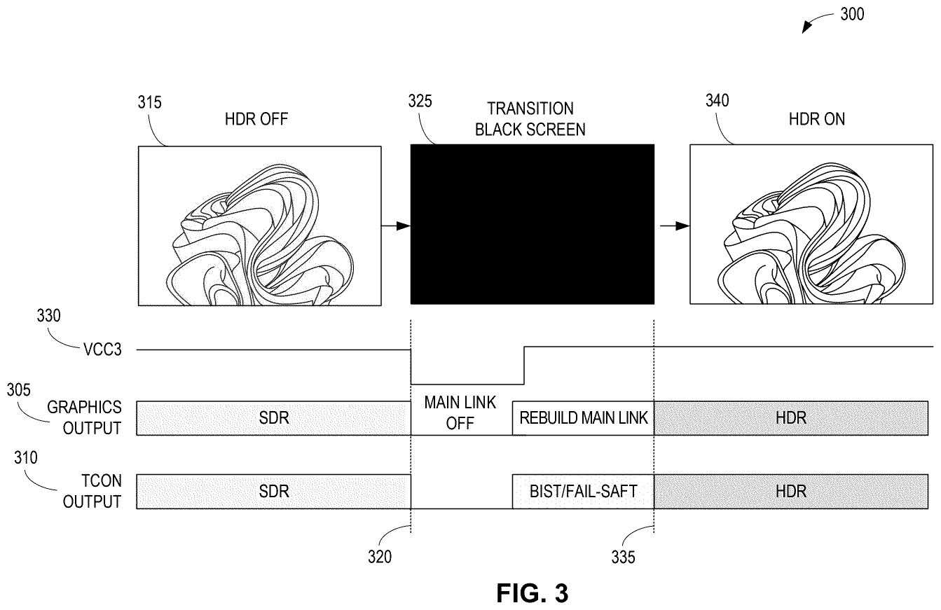

For reference, FIG. 3 illustrates an example scenario 300 in which a display device is switched from a standard dynamic range to a high dynamic range without seamless dynamic range switching as implemented by the compute system 100 of FIG. 1. The scenario 300 of the illustrated example begins with an example graphics output 305 provided to the display device having standard dynamic range. Thus, the TCON of the display device also provides an example graphics data output 310 that has standard dynamic range to the display panel of the display device. As a result, the display panel presents an example output image 315 that has standard dynamic range.

Next, at time 320, the graphics output 305 is switched from standard dynamic range to high dynamic range (e.g., based on user input). Because seamless switching is not supported in the scenario 300, the switch from standard dynamic range to high dynamic range causes the display panel of the display device to display a blank screen (e.g., black screen) 325 during the transition from standard dynamic range to high dynamic range. The blank screen 325 is caused by the display device power 330 being reset, which causes the graphics output 305 and TCON output 310 to be reset, thereby rebuilding the graphics link between the host device and the display device. In the scenario 300, the graphics link is rebuilt to support a higher bandwidth due to the switch from an 8-bit color space to a 10-bit or 12-bit color space.

After the link is rebuilt, at time 335, the graphics output 305 has switched to having high dynamic range. Thus, the TCON output 310 also has high dynamic range. As a result, the display panel presents an example output image 340 that has high dynamic range. In the example scenario 300, the blank screen transition 325 can last several seconds and result in a bad visual experience due to the visual flow being disrupted on the display panel.

Returning to FIG. 1, to implement seamless dynamic range switching, the graphics engine circuitry 125 of the illustrated example is configured to instruct, command or otherwise cause the display device 110 to activate panel self refresh after the graphics engine circuitry 125 receives a command from the graphics driver 120 to switch the dynamic range of its graphics output. In the illustrated example, the graphics engine circuitry 125 of the illustrated example also instructs, commands or otherwise causes the display device 110 to activate panel self refresh before initiating the switch of the dynamic range of the graphics output. In the illustrated example, the graphics engine circuitry 125 of the illustrated example further instructs, commands or otherwise causes the display device 110 to deactivate panel self refresh after the switch of the dynamic range of the graphics output has completed.

In some examples, after receipt of a command from the graphics driver 120 to switch the dynamic range of its graphics output, but before initiating the switch, the graphics engine circuitry 125 generates and sends a command via the display interface circuitry 130 to cause the display device 110 to activate panel self refresh. For example, the dynamic range switch command from the graphics driver 120 can be a command to switch the graphics output of the graphics engine circuitry 125 from standard dynamic range to high dynamic range, or from high dynamic range to standard dynamic range. In some examples, the graphics driver 120 also provides a separate panel self refresh activate command to the graphics engine circuitry 125, which causes the graphics engine circuitry 125 to send the panel self refresh activate command via the display interface circuitry 130 to cause the display device 110 to active panel self refresh. In some examples, the graphics engine circuitry 125 waits until after the panel self refresh activate command has been sent to the display device 110 to then initiate the actual switch of the dynamic range of the graphics output (e.g., from standard dynamic range to high dynamic range, or from high dynamic range to standard dynamic range).

In some examples, after the graphics engine circuitry 125 completes switching the dynamic range of its graphics output, the graphics engine circuitry 125 generates and sends a command via the display interface circuitry 130 to cause the display device 110 to deactivate panel self refresh. In some examples, the graphics driver 120 also provides a separate panel self refresh deactivate command to the graphics engine circuitry 125, which causes the graphics engine circuitry 125 to send the panel self refresh deactivate command via the display interface circuitry 130 to cause the display device 110 to deactivate panel self refresh.

In the illustrated example, to implement seamless dynamic range switching, the power control circuitry 155 is configured to maintain system power (e.g., VCC) of the display device 110 active (e.g., high) after the graphics engine circuitry 125 causes the display device 110 to activate panel self refresh. For example, the power control circuitry 155 may be configured to continue providing power to the other circuitry of the display device 110, such as the display panel 135, the panel interface circuitry 140, the timing controller circuitry 145 and the host interface circuitry 150 after the graphics engine circuitry 125 causes the display device 110 to activate panel self refresh. In some examples, the power control circuitry 155 is configured to maintain system power (e.g., VCC) of the display device 110 active (e.g., high) after receipt of a command (e.g., a panel self refresh activate command) from the graphics engine circuitry 125 via the host interface circuitry 150 to cause the display device 110 to activate panel self refresh.

In the illustrated example, to implement seamless dynamic range switching, the TCON 145 is configured to activate panel self refresh in the display device 110 after receipt of a command (e.g., a panel self refresh activate command) from the graphics engine circuitry 125 via the host interface circuitry 150. In some examples, the TCON 145 implements this panel self refresh activation functionality in addition to activating panel self refresh when no new frame updates are received from the host device 105.

In the illustrated example, to implement seamless dynamic range switching, the graphics driver 120 (and/or the host OS 115) is configured to omit providing one or more commands to the graphics driver 120 that may cause panel self refresh to be deactivated prematurely while the dynamic range of the graphics output is being switched. For example, some other graphics driver and host OS implementations provide a frame update (e.g., also referred to as a flip) containing a blank frame (e.g., a black frame) to the graphics engine circuitry 125 prior to switching the dynamic range of the graphics output. Also, some other graphics driver and host OS implementations provide a visibility off command to the graphics engine circuitry 125 prior to switching the dynamic range of the graphics output. In some such examples, the frame update with the blank frame (e.g., a black frame) and the visibility off command cause the display device 110 to present a blank frame (e.g., a black frame) rather than random graphics data while the dynamic range of the graphics output is being switched. However, providing a frame update can cause panel self refresh to be deactivated by the display device 110. Thus, in the illustrated example, the graphics driver 120 (and/or the host OS 115) is configured to omit providing a blank frame update and the visibility off command after the command from the graphics driver 120 to the graphics engine circuitry 125 to switch the dynamic range of the graphics output. In this way, the graphics engine circuitry 125 pauses or halts frame updates to the display device 110 after panel self refresh is activated for the purpose of seamless dynamic range switching. The graphics engine circuitry 125 can then resume frame updates after seamless dynamic range switching has completed and the panel self refresh has been deactivated.

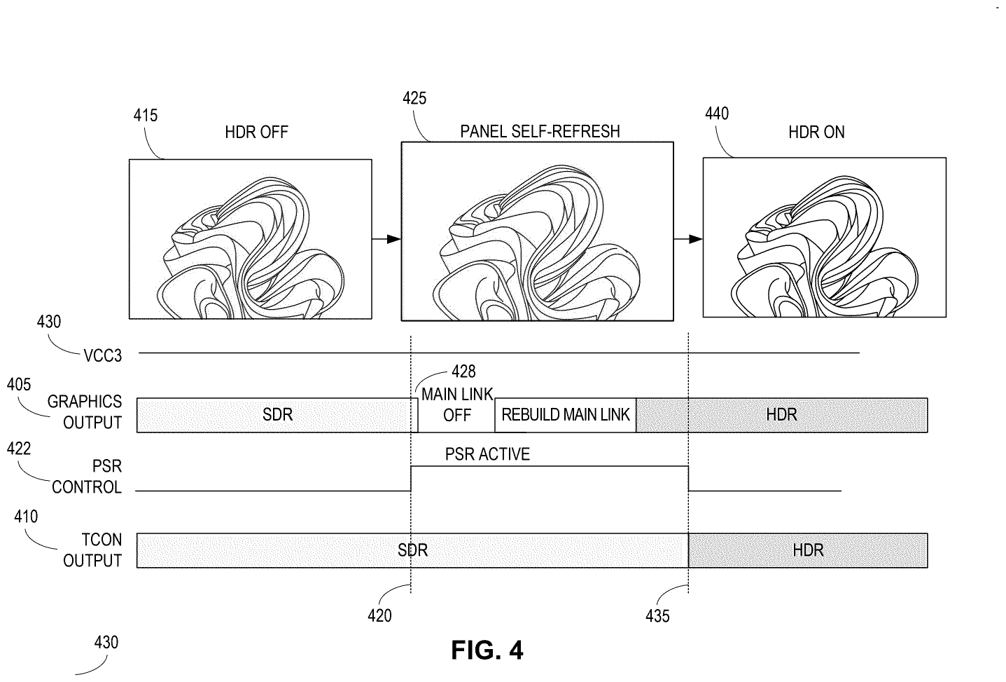

FIG. 4 illustrates an example scenario 400 in which the compute system 100 of FIG. 1 performs seamless switching of the display device 110 from standard dynamic range to high dynamic range. As used herein, switching the dynamic range of the display device 110 is equivalent to switching the dynamic range of the graphics output of the graphics engine circuitry 125, unless specified otherwise. Also, as used herein, switching the dynamic range of the display device 110 is equivalent to switching the graphics mode of the display device 110 from a first dynamic range to a second dynamic range, unless specified otherwise. The scenario 400 of the illustrated example begins with the graphics engine circuitry 125 providing an example graphics output 405 having standard dynamic range to the display device 110. Thus, the TCON 145 of the display device 110 also provides an example graphics data output 410 that has standard dynamic range to the display panel 135 of the display device 110. As a result, the display panel 135 presents an example output image 415 that has standard dynamic range.

Next, at time 420, the graphics engine circuitry 125 receives a command from the graphics driver 120 to switch its graphics output 405 from standard dynamic range to high dynamic range (e.g., based on user input). Because seamless switching is supported in the scenario 400, the graphics engine circuitry 125 sends a panel self refresh activate command in the form of an example panel self refresh (PSR) control signal 422 via the panel interface circuitry 140, which causes the display device 110 to activate panel self refresh. Activating panel self refresh causes the display panel 135 of the display device 110 to present an example output image 425 that has standard dynamic range. In some examples, the output image 425 corresponds to the most recent frame received from the graphics output 405 of the graphics driver 120 before panel self refresh was activated.

Next, at time 428, which is after time 420, the graphics engine circuitry 125 initiates the switch from standard dynamic range to high dynamic range. Thus, at time 428, the graphics output 405 resets and the graphics engine circuitry 125 rebuilds the graphics link between the host device 105 and the display device 110. In the scenario 400, the graphics link is rebuilt to support a higher bandwidth due to the switch from an 8-bit color space to a 10-bit or 12-bit color space. Notably, in contrast with the scenario 300 of FIG. 3, in the scenario 400 of FIG. 4, the display device power 430 provided by the power control circuitry 155 remains active (e.g., high, on, etc.), which allows the output image 425 image to be displayed while the dynamic range is being switched. Furthermore, because the display device power 430 provided by the power control circuitry 155 remains active, the TCON 145 is not reset and, thus, does not incur delay to perform built-in self-test and associated operations.

After the link is rebuilt, at time 435, graphics engine circuitry 125 has switched its graphics output 405 to have high dynamic range. Thus, the TCON output 410 also has high dynamic range. As a result, the display device 110 presents an example output image 440 that has high dynamic range. In the example scenario 400, there is no blank screen transition during the seamless switch from standard dynamic range to high dynamic range, which results in a good visual experience because the visual flow on the display panel 135 is not disrupted.

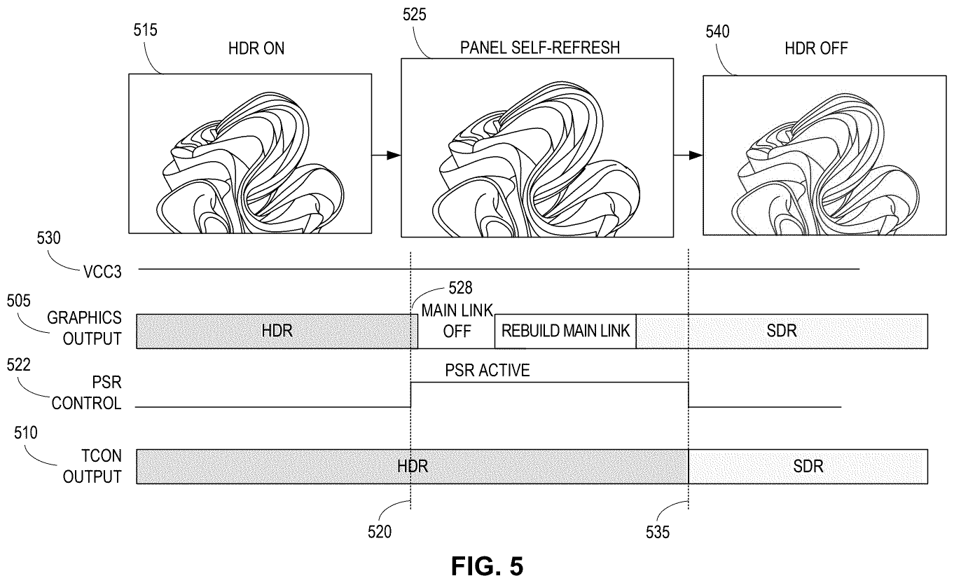

FIG. 5 illustrates an example scenario 500 in which the compute system 100 of FIG. 1 performs seamless switching of the display device 110 from high dynamic range to standard dynamic range. As used herein, switching the dynamic range of the display device 110 is equivalent to switching the dynamic range of the graphics output of the graphics engine circuitry 125, unless specified otherwise. Also, as used herein, switching the dynamic range of the display device 110 is equivalent to switching the graphics mode of the display device 110 from a first dynamic range to a second dynamic range, unless specified otherwise. The scenario 500 of the illustrated example begins with the graphics engine circuitry 125 providing an example graphics output 505 having high dynamic range to the display device 110. Thus, the TCON 145 of the display device 110 also provides an example graphics data output 510 that has high dynamic range to the display panel 135 of the display device 110. As a result, the display panel 135 presents an example output image 515 that has high dynamic range.

Next, at time 520, the graphics engine circuitry 125 receives a command from the graphics driver 120 to switch its graphics output 505 from high dynamic range to standard dynamic range (e.g., based on user input). Because seamless switching is supported in the scenario 500, the graphics engine circuitry 125 sends a panel self refresh activate command in the form of an example PSR control signal 522 via the panel interface circuitry 140, which causes the display device 110 to activate panel self refresh. Activating panel self refresh causes the display panel 135 of the display device 110 to present an example output image 525 that has high dynamic range. In some examples, the output image 525 corresponds to the most recent frame received from the graphics output 505 of the graphics driver 120 before panel self refresh was activated.

Next, at time 528, which is after time 520, the graphics engine circuitry 125 initiates the switch from high dynamic range to standard dynamic range. Thus, at time 428, the graphics output 505 resets and the graphics engine circuitry 125 rebuilds the graphics link between the host device 105 and the display device 110. In the scenario 500, the graphics link is rebuilt to support a lower bandwidth due to the switch from a 10-bit or 12-bit color space to an 8-bit color space. Notably, in contrast with the scenario 300 of FIG. 3, in the scenario 500 of FIG. 5, the display device power 530 provided by the power control circuitry 155 remains active (e.g., high, on, etc.), which allows the output image 525 image to be displayed while the dynamic range is being switched. Furthermore, because the display device power 530 provided by the power control circuitry 155 remains active, the TCON 145 is not reset and, thus, does not incur delay to perform built-in self-test and associated operations.

After the link is rebuilt, at time 535, graphics engine circuitry 125 has switched its graphics output 505 to have standard dynamic range. Thus, the TCON output 510 also has standard dynamic range. As a result, the display device 110 presents an example output image 440 that has standard dynamic range. In the example scenario 500, there is no blank screen transition during the seamless switch from high dynamic range to standard dynamic range, which results in a good visual experience because the visual flow on the display panel 135 is not disrupted.

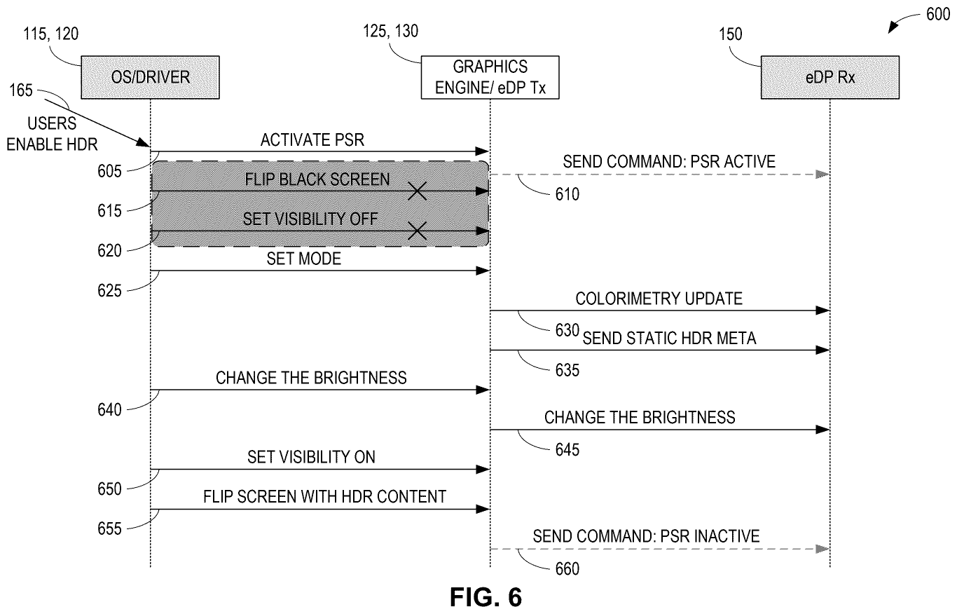

FIG. 6 illustrates an example sequence diagram 600 depicting example commands and operations used by the compute system 100 of FIG. 1 to implement seamless switching of the display device 110 from one dynamic range to another dynamic range. As used herein, switching the dynamic range of the display device 110 is equivalent to switching the dynamic range of the graphics output of the graphics engine circuitry 125, unless specified otherwise. Also, as used herein, switching the dynamic range of the display device 110 is equivalent to switching the graphics mode of the display device 110 from a first dynamic range to a second dynamic range, unless specified otherwise. The sequence diagram 600 depicts seamless switching of the display device 110 from standard dynamic range to high dynamic range. The sequence diagram 600 of the illustrated example begins with the host OS 115 and/or the graphics driver 120 of the host device 105 receiving a user input 165 to set/switch the display device 110 from standard dynamic range high dynamic range. As used herein, switching the dynamic range of the display device 110 is equivalent to switching the dynamic range of the graphics output of the graphics engine circuitry 125, unless specified otherwise.

After receipt of the user input 165, the graphics driver 120 sends an example activate PSR command 605 to the graphics engine circuitry 125 of the host device 105. The graphics engine circuitry 125, in turn, sends an example PSR activate command 610 via the panel interface circuitry 140 of the host device 105 to the host interface circuitry 150 of the display device 110. The PSR active command 610 causes the display device 110 to activate panel self refresh. The sequence diagram 600 of the illustrated example also shows that the host OS 115 and/or graphics driver 120 omit sending a blank screen (e.g., black screen) frame update 615 and a set visibility off command 620 to the display device 110, thereby avoiding premature deactivation of panel self refresh in the display device 110.

Next, the graphics driver 120 sends an example set mode command 625 to the graphics engine circuitry 125, which causes the graphics engine circuitry 125 to initiate switching from standard dynamic range to high dynamic range. For example, the graphics engine circuitry 125 sends an example colorimetry update 630 and example high dynamic range metadata 635 via the panel interface circuitry 140 to the host interface circuitry 150 of the display device 110, which is used by the display device 110 to switch from standard dynamic range to high dynamic range. In the illustrated example, the graphics driver 120 sends also sends an example brightness change command 640 to the graphics engine circuitry 125, which causes the graphics engine circuitry 125 to send a corresponding example brightness change command 645 via the panel interface circuitry 140 to the host interface circuitry 150 of the display device 110.

After the switch to high dynamic range is complete, the graphics driver 120 sends an example set mode command 625 to the graphics engine circuitry 125 and begins sending example frame updates 655 that include high dynamic range graphics data to the graphics engine circuitry 125. The graphics engine circuitry 125 then sends an example PSR inactive command 660 via the panel interface circuitry 140 of the host device 105 to the host interface circuitry 150 of the display device 110. The PSR inactive command 660 causes the display device 110 to deactivate panel self refresh, which permits the display device 110 to receive the frame updates 655 that include high dynamic range graphics data. The sequence diagram 600 then ends.

A similar sequence diagram can be constructed to depict the commands and operations used by the compute system 100 to perform seamless switching of the display device 110 from high dynamic range to standard dynamic range. For example, such a sequence diagram can be constructed by replacing “HDR” (which refers to high dynamic range) with “SDR” (which refers to standard dynamic range) in the message sequence diagram 600.

Returning to FIG. 1, the compute system 100 of the illustrated example also supports seamless refresh rate switching. As mentioned above, a high refresh rate can consume more power but produce higher graphics quality, whereas a low refresh rate can consume less power but produce lower graphics quality. Thus, some systems utilize a high refresh rate when plugged into an active power source or are otherwise operating under line power, and utilize a low refresh rate when operating under battery power.

Two techniques implemented by some compute systems to switch refresh rates are: (i) refresh rate switching based on detailed timing description (DTD), and (ii) variable refresh rate (VRR), which are both based on VESA® standards. VRR-based refresh rate switching enables the refresh rate to be switched without the display of a blank screen (e.g., black screen), whereas DTD-based refresh rate switching results in a blank screen (e.g., black screen) being displayed during the refresh rate switch. Thus, VRR-based refresh rate switching may provide a better user experience than DTD-based refresh rate switching because the visual flow is not interrupted by a blank screen (e.g., black screen). However, VRR-based refresh rate switching uses the same pixel clock rate (e.g., 120 Hz) in both its high refresh rate (e.g., 120 Hz) and its low refresh rate (e.g., 60 Hz) modes, wherein DTD-based refresh rate switching permits the use of a lower pixel clock rate (e.g., 60 Hz) in its low refresh rate (e.g., 60 Hz) mode. Thus, DTD-based refresh rate switching can achieve a low refresh rate with reduced power consumption relative to the low refresh rate achieved with VRR-based refresh rate switching.

In the illustrated example of FIG. 1, the compute system 100 utilizes DTD-based refresh rate switching in combination with panel self refresh to implement its seamless refresh rate switching. Thus, the compute system 100 is able to achieve a user experience consistent with VRR-based refresh rate switching but with improved power consumption and battery life. As described above in connection with FIG. 2, the graphics driver 120 of the host device 105 provides a user interface 200 that allows a user to select that the graphics output from the graphics engine circuitry 125 is to have a dynamic refresh rate that is switched between the low refresh rate (e.g., 60 Hz) and the high refresh rate (e.g., 120 Hz) based on one or more operating conditions of the compute system 100. For example, the dynamic refresh rate setting can cause the graphics driver 120 to switch to the low refresh rate (e.g., 60 Hz) when the compute system 100 is operating under battery power, and switch to the high refresh rate (e.g., 120 Hz) when the compute system 100 is operating under active line power.

In the illustrated example of FIG. 1, to implement seamless refresh rate switching, the graphics engine circuitry 125 is configured to instruct, command or otherwise cause the display device 110 to activate panel self refresh after the graphics engine circuitry 125 receives a command from the graphics driver 120 to switch the refresh rate of its graphics output. In the illustrated example, the graphics engine circuitry 125 of the illustrated example also instructs, commands or otherwise causes the display device 110 to activate panel self refresh before initiating the switch of the refresh rate of the graphics output. In the illustrated example, the graphics engine circuitry 125 of the illustrated example further instructs, commands or otherwise causes the display device 110 to deactivate panel self refresh after the switch of the refresh rate of the graphics output has completed.

In some examples, after receipt of a command from the graphics driver 120 to switch the refresh rate of its graphics output, but before initiating the switch, the graphics engine circuitry 125 generates and sends a command via the display interface circuitry 130 to cause the display device 110 to activate panel self refresh. For example, the graphics driver 120 may provide a command to switch the graphics output from a high refresh rate (e.g., 120 Hz) to a low refresh rate (e.g., 60 Hz) based on an instruction from the host OS 115 indicating the host device 115 has been disconnected from line power (e.g., AC power) and is operating under battery power (e.g., DC power). As another example, the graphics driver 120 may provide a command to switch the graphics output from the low refresh rate (e.g., 60 Hz) to the high refresh rate (e.g., 120 Hz) based on an instruction from the host OS 115 indicating the host device 115 has been connected to line power (e.g., AC power) and is no longer operating under battery power (e.g., DC power). In some examples, the graphics driver 120 also provides a separate panel self refresh activate command to the graphics engine circuitry 125, which causes the graphics engine circuitry 125 to send the panel self refresh activate command via the display interface circuitry 130 to cause the display device 110 to active panel self refresh. In some examples, the graphics engine circuitry 125 waits until after the panel self refresh activate command has been sent to the display device 110 to then initiate the actual switch of the refresh rate of the graphics output.

In some examples, after the graphics engine circuitry 125 completes switching the refresh rate of its graphics output, the graphics engine circuitry 125 generates and sends a command via the display interface circuitry 130 to cause the display device 110 to deactivate panel self refresh. In some examples, the graphics driver 120 also provides a separate panel self refresh deactivate command to the graphics engine circuitry 125, which causes the graphics engine circuitry 125 to send the panel self refresh deactivate command via the display interface circuitry 130 to cause the display device 110 to deactivate panel self refresh.

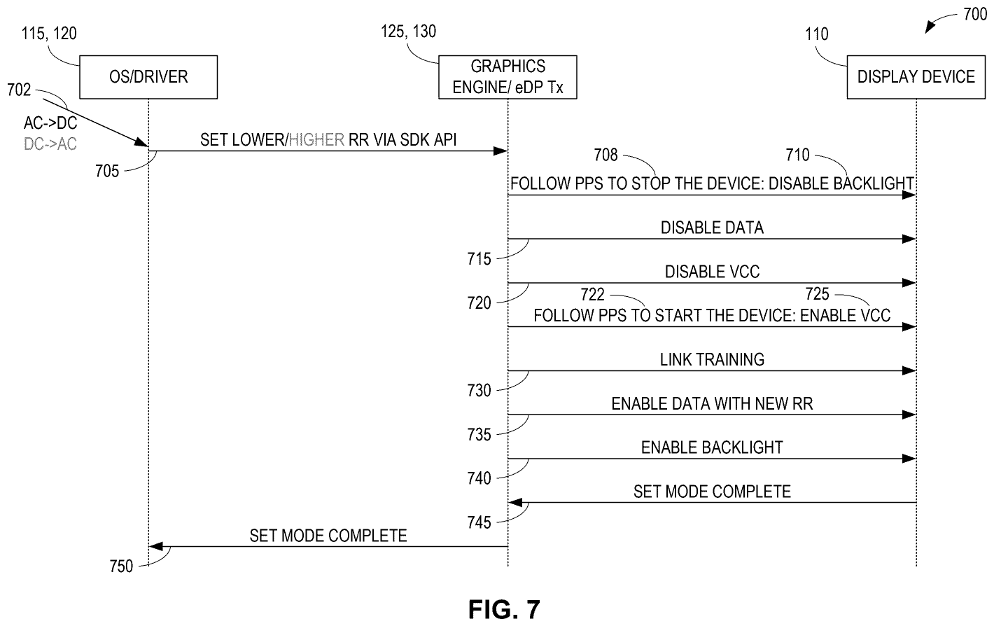

FIG. 7 illustrates an example sequence diagram 700 depicting commands and operations used by the compute system 100 of FIG. 1 to cause a refresh rate of the display device 110 to be switched when seamless refresh rate switching is not enabled in the compute system 100 of FIG. 1. As used herein, switching the refresh rate of the display device 110 is equivalent to switching the refresh rate of the graphics output of the graphics engine circuitry 125, unless specified otherwise. Also, as used herein, switching the dynamic range of the display device 110 is equivalent to switching the graphics mode of the display device 110 from a first dynamic range to a second dynamic range, unless specified otherwise. The sequence diagram 700 of the illustrated example begins with the host OS 115 detecting an operating condition 702 that causes the refresh rate to be changed to a new refresh rate. For example, the operating condition 702 can correspond to the compute system 100 transitioning from line power (e.g., AC power) to battery power (e.g., DC power), or transitioning from battery power (e.g., DC power) to line power (e.g., AC power).

After detection of the operating condition 702, the graphics driver 120 sends a command 705 to the graphics engine circuitry 125 to switch to the new refresh rate. In the sequence diagram 700, the graphics driver 120 generates the command 705 based on a software development kit (SDK) application programing interface (API) call from the host OS 115. Based on the command 705, the graphics engine circuitry 125 initiates a panel power sequence (PPS) 708 to stop the display device 110. The PPS 708 includes sending a command 710 to disable the backlight of the display device 110, performing an operation 715 to disable the graphics output provided to the display device 110, and sending a command 720 to disable system power of the display device 110.

Next, the graphics engine circuitry 125 initiates a PPS 722 to start the display device 110 with the new refresh rate. The PPS 722 includes sending a command 725 to enable system power of the display device 110, performing a link training operation 730 to retrain the link between the host device 105 and the display device 110 to operate at the new refresh rate, performing an operation 735 to enable the graphics output provided to the display device 110 at the new refresh rate, and sending a command 740 to enable the backlight of the display device 110.

Next, the graphics engine circuitry 125 receives a response 745 from the display device 110 indicating the setting of the new refresh rate is complete. The graphic engine circuitry 125, in turn, provide a response 750 to the graphics driver 120 indicating the setting of the new refresh rate is complete. The sequence diagram 700 then ends. Similar to the example scenario 300 described above, the procedure for refresh rate switching illustrated in FIG. 7 includes a blank screen transition that can last several seconds and results in a bad visual experience due to the visual flow being disrupted on the display panel.

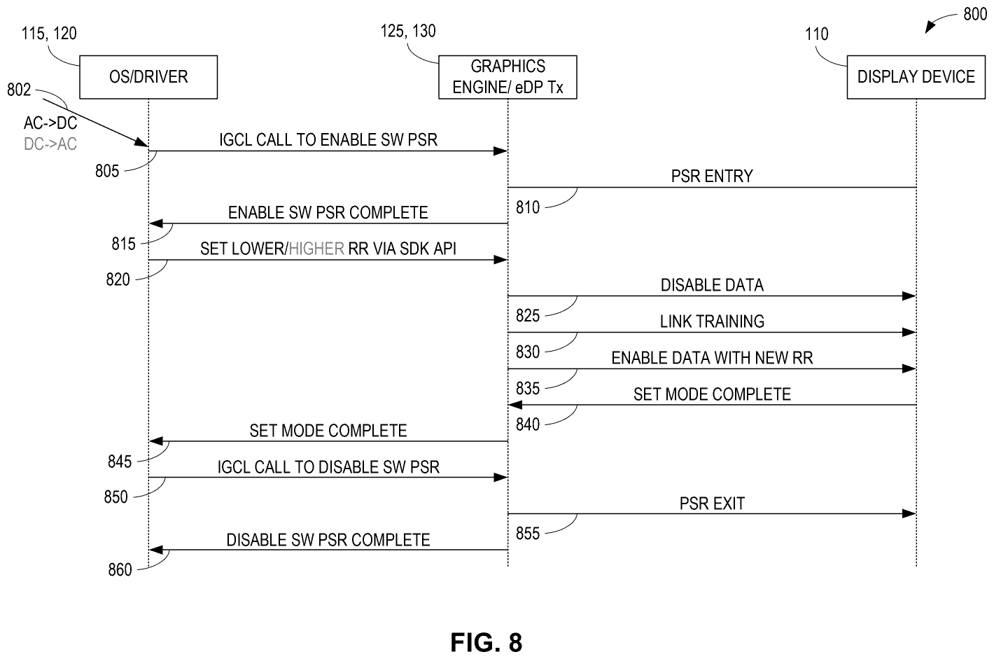

FIG. 8 illustrates an example sequence diagram 800 depicting example commands and operations used by the compute system 100 of FIG. 1 to cause a refresh rate of the display device 110 to be switched when seamless refresh rate switching is enabled in the compute system 100 of FIG. 1. As used herein, switching the refresh rate of the display device 110 is equivalent to switching the refresh rate of the graphics output of the graphics engine circuitry 125, unless specified otherwise. Also, as used herein, switching the dynamic range of the display device 110 is equivalent to switching the graphics mode of the display device 110 from a first dynamic range to a second dynamic range, unless specified otherwise. The sequence diagram 800 of the illustrated example begins with the host OS 115 detecting an operating condition 802 that causes the refresh rate to be changed to a new refresh rate. For example, the operating condition 802 can correspond to the compute system 100 transitioning from line power (e.g., AC power) to battery power (e.g., DC power), or transitioning from battery power (e.g., DC power) to line power (e.g., AC power).

After detection of the operating condition 802, the graphics driver 120 sends an example activate PSR command 805 to the graphics engine circuitry 125 to instruct the graphics engine circuitry 125 to activate panel self refresh in the display device 110. For example, the activate PSR command 805 can be implemented with an Intel® Graphics Call Library instruction or any other appropriate instruction, command, signal, etc. Based on the activate PSR command 805, the graphics engine circuitry 125, in turn, sends an example PSR activate command 810 via the panel interface circuitry 140 of the host device 105 to the host interface circuitry 150 of the display device 110. The PSR active command 610 causes the display device 110 to activate panel self refresh. The graphics engine circuitry 125 then sends an example PSR enabled response 815 to the graphics driver 120 to indicate that panel self refresh has been activated in the display device 110.

Next, the graphics driver 120 sends an example command 820 to the graphics engine circuitry 125 to switch to the new refresh rate. In the sequence diagram 800, the graphics driver 120 generates the command 705 based on an SDK API call from the host OS 115. Based on the command 805, the graphics engine circuitry 125 performs an example operation 825 to disable the graphics output provided to the display device 110. The graphics engine circuitry 125 then performs an example link training operation 830 to retrain the link between the host device 105 and the display device 110 to operate at the new refresh rate. The graphics engine circuitry 125 then performs an example operation 835 to enable the graphics output provided to the display device 110 at the new refresh rate.

Next, the graphics engine circuitry 125 receives an example response 840 from the display device 110 indicating the setting of the new refresh rate is complete. The graphic engine circuitry 125, in turn, provides an example response 845 to the graphics driver 120 indicating the setting of the new refresh rate is complete.

Next, the graphics driver 120 sends an example deactivate PSR command 850 to the graphics engine circuitry 125 to instruct the graphics engine circuitry 125 to deactivate panel self refresh in the display device 110. For example, the deactivate PSR command 850 can be implemented with an Intel® Graphics Call Library instruction or any other appropriate instruction, command, signal, etc. Based on the deactivate PSR command 850, the graphics engine circuitry 125, in turn, sends an example PSR deactivate command 855 via the panel interface circuitry 140 of the host device 105 to the host interface circuitry 150 of the display device 110. The PSR deactivate command 855 causes the display device 110 to deactivate panel self refresh. The graphics engine circuitry 125 then sends an example PSR disabled response 860 to the graphics driver 120 to indicate that panel self refresh has been deactivated in the display device 110. The sequence diagram 800 then ends. Similar to the example scenarios 400 and 500 described above, there is no blank screen transition during the seamless refresh rate switching of FIG. 8, which results in a good visual experience because the visual flow on the display panel 135 is not disrupted.

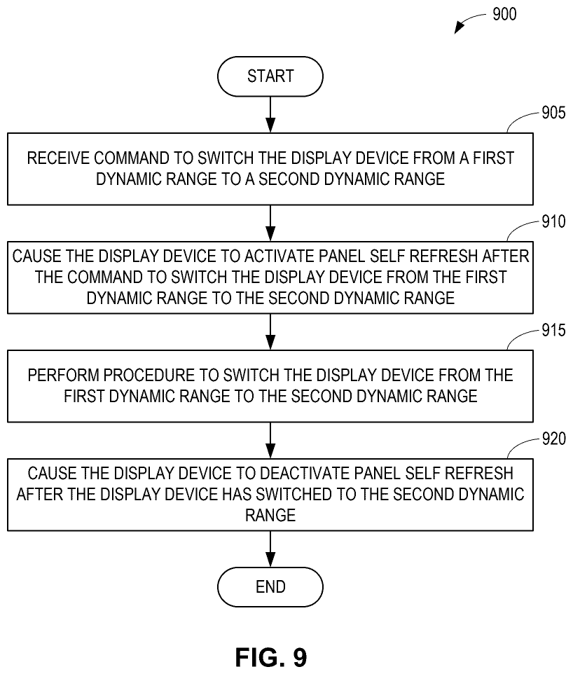

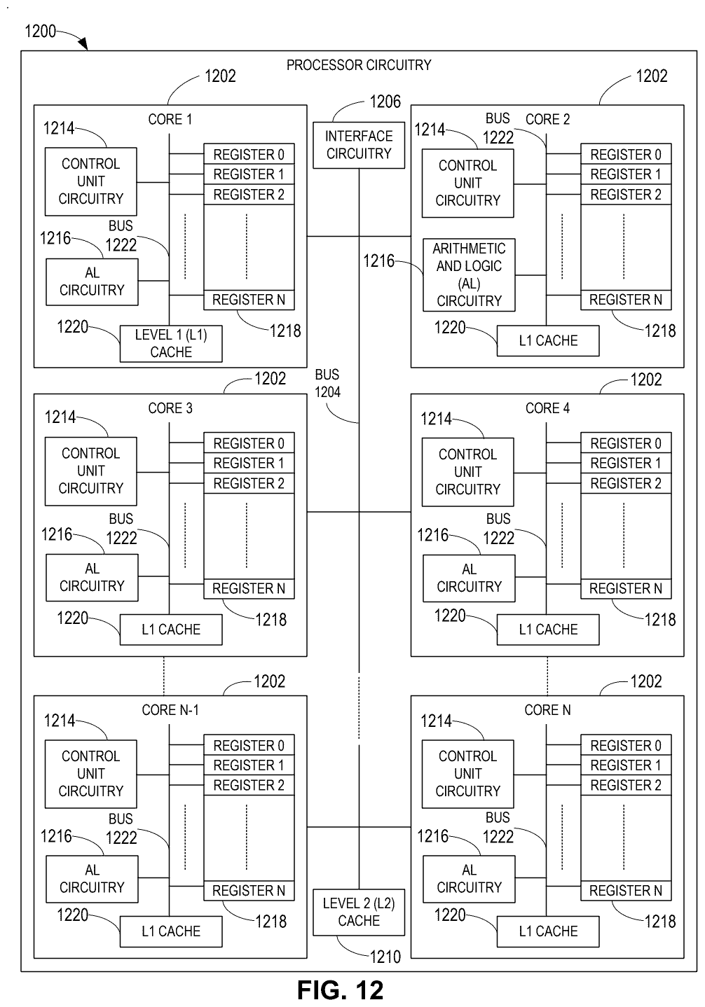

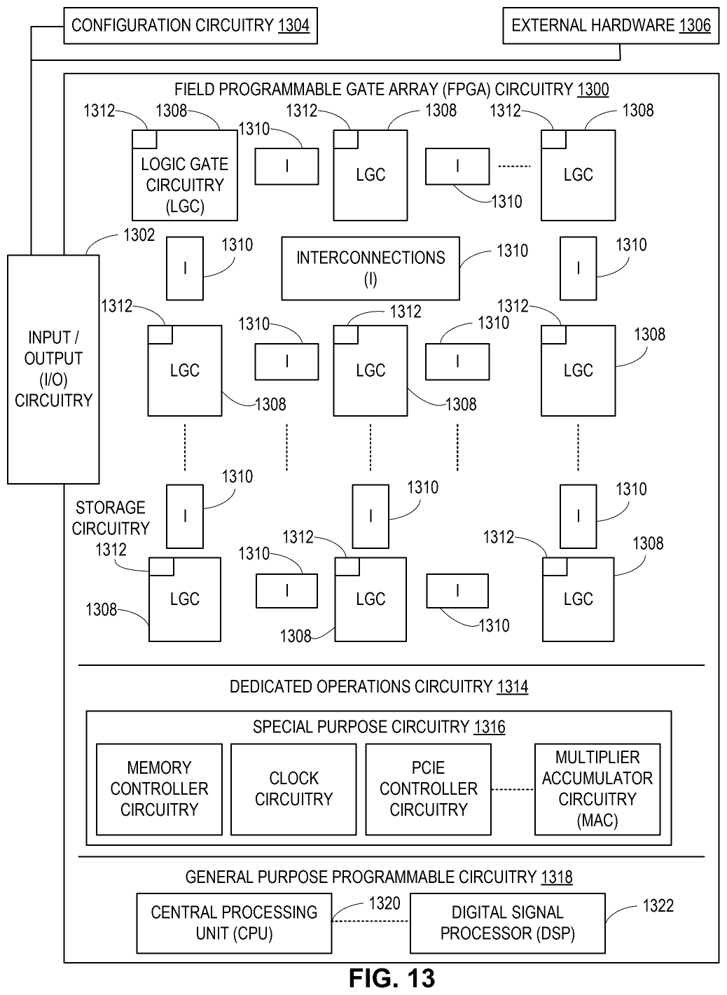

In some examples, the compute system 100 includes means for performing seamless dynamic range switching. In some examples, the compute system 100 includes means for performing seamless refresh rate switching. For example, the means for performing seamless dynamic range switching and/or the means for performing seamless refresh rate switching may be implemented by the graphics engine circuitry 125. In some examples, the graphics engine circuitry 125 may be instantiated by programmable circuitry such as the example programmable circuitry 1112 of FIG. 11. For instance, the graphics engine circuitry 125 may be instantiated by the example microprocessor 1200 of FIG. 12 executing machine executable instructions such as those implemented by at least blocks 904-920 of FIG. 9. In some examples, the graphics engine circuitry 125 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the graphics engine circuitry 125 may be instantiated by any other combination of hardware, software, and/or firmware. For example, the graphics engine circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the compute system 100 is illustrated in FIGS. 1-8, one or more of the elements, processes, and/or devices illustrated in FIGS. 1-8 may be combined, divided, re-arranged, omitted, eliminated, and/or implemented in any other way. Further, the example host device 105, the example display device 110, the example host OS 115, the example graphics driver 120, the example graphics engine circuitry 125, the example display interface circuitry 130, the example display panel 135, the example panel interface circuitry 140, the example timing controller circuitry 145, the host interface circuitry 150, the power control circuitry 155, the example framebuffer 160, and/or, more generally, the example compute system 100, may be implemented by hardware alone or by hardware in combination with software and/or firmware. Thus, for example, any of the example host device 105, the example display device 110, the example host OS 115, the example graphics driver 120, the example graphics engine circuitry 125, the example display interface circuitry 130, the example display panel 135, the example panel interface circuitry 140, the example timing controller circuitry 145, the host interface circuitry 150, the power control circuitry 155, the example framebuffer 160, and/or, more generally, the example compute system 100, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example compute system 100 may include one or more elements, processes, and/or devices in addition to, or instead of, those illustrated in FIGS. 1-8, and/or may include more than one of any or all of the illustrated elements, processes and devices.

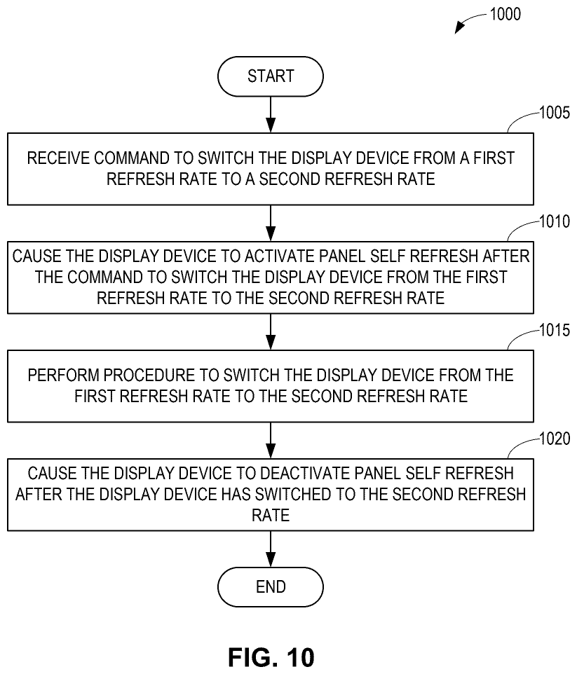

Flowchart(s) representative of example machine-readable instructions, which may be executed by programmable circuitry to implement and/or instantiate the compute system 100 of FIGS. 1-8 and/or representative of example operations which may be performed by programmable circuitry to implement and/or instantiate the compute system 100 of FIGS. 1-8, are shown in FIGS. 9-10. The machine-readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 9-10, many other methods of implementing the example compute system 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 9-10 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9 is a flowchart representative of example machine-readable instructions and/or example operations 900 that may be executed, instantiated, and/or performed by programmable circuitry to implement seamless dynamic range switching in the example compute system 100 of FIG. 1. The example machine-readable instructions and/or the example operations 900 of FIG. 9 begin at block 905, at which the graphics engine circuitry 125 receives a command from the graphics driver 120 to switch the display device 110 from a first dynamic range to a second dynamic range, as described above. At block 910, the graphics engine circuitry 125 causes the display device 110 to activate panel self refresh after receipt the command to switch the display device 110 from the first dynamic range to the second dynamic range, as described above. At block 915, the graphics engine circuitry 125 performs the procedure described above to switch the display device from the first dynamic range to the second dynamic range. At block 920, the graphics engine circuitry 125 causes the display device 110 to deactivate panel self refresh after the display device 110 has switched to the second dynamic range. The example machine-readable instructions and/or the example operations 900 then end.

FIG. 10 is a flowchart representative of example machine-readable instructions and/or example operations 1000 that may be executed, instantiated, and/or performed by programmable circuitry to implement seamless refresh rate switching in the example compute system 100 of FIG. 1. The example machine-readable instructions and/or the example operations 1000 of FIG. 10 begin at block 1005, at which the graphics engine circuitry 125 receives a command from the graphics driver 120 to switch the display device 110 from a first refresh rate to a second refresh rate, as described above. At block 1010, the graphics engine circuitry 125 causes the display device 110 to activate panel self refresh after receipt the command to switch the display device 110 from the first refresh rate to the second refresh rate, as described above. At block 1015, the graphics engine circuitry 125 performs the procedure described above to switch the display device from the first refresh rate to the second refresh rate. At block 1020, the graphics engine circuitry 125 causes the display device 110 to deactivate panel self refresh after the display device 110 has switched to the second refresh rate. The example machine-readable instructions and/or the example operations 1000 then end.

FIG. 11 is a block diagram of an example programmable circuitry platform 1100 structured to execute and/or instantiate the example machine-readable instructions and/or the example operations of FIGS. 9-10 to implement the compute system 100 of FIGS. 1-8. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the host OS 115, the graphics driver 120 and/or the graphics engine circuitry 125.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In the illustrated example, the interface circuitry 1120 implements the display interface circuitry 130.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU. In the illustrated example, the output devices 1124 include the display device 110.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which may be implemented by the machine-readable instructions of FIGS. 9-10, may be stored in the mass storage device 1128, in the volatile memory 1114, in the non-volatile memory 1116, and/or on at least one non-transitory computer-readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 9-10 to effectively instantiate the circuitry of FIG. 1 as logic circuits to perform operations corresponding to those machine-readable instructions. In some such examples, the circuitry of FIG. 1 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine-readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 9-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematical and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine-readable instructions represented by the flowchart(s) of FIGS. 9-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 9-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9-10. As such, the FPGA circuitry 1300 may be configured and/or structured to effectively instantiate some or all of the operations/functions corresponding to the machine-readable instructions of the flowchart(s) of FIGS. 9-10 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 9-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 9-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine-readable instructions represented by the flowchart(s) of FIGS. 9-10 to perform first operation(s)/function(s), the FPGA circuitry 1300 of FIG. 13 may be configured and/or structured to perform second operation(s)/function(s) corresponding to a second portion of the machine-readable instructions represented by the flowcharts of FIGS. 9-10, and/or an ASIC may be configured and/or structured to perform third operation(s)/function(s) corresponding to a third portion of the machine-readable instructions represented by the flowcharts of FIGS. 9-10.

It should be understood that some or all of the circuitry of FIG. 1 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1200 of FIG. 12 may execute machine-readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 1 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

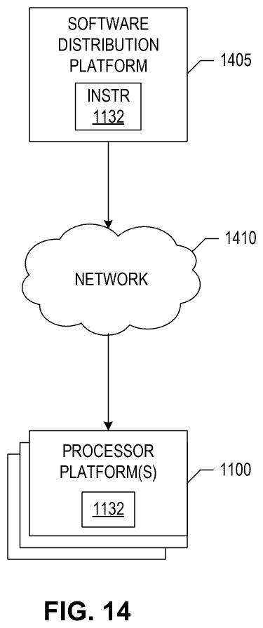

A block diagram illustrating an example software distribution platform 1405 to distribute software such as the example machine-readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine-readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine-readable instructions of FIGS. 9-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1132 from the software distribution platform 1405. For example, the software, which may correspond to the example machine-readable instructions of FIG. 9-10, may be downloaded to the example programmable circuitry platform 1100, which is to execute the machine-readable instructions 1132 to implement the compute system 100. In some examples, one or more servers of the software distribution platform 1405 periodically offer, transmit, and/or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/of” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement seamless switching of dynamic ranges and/or refresh rates on display devices. Disclosed systems, apparatus, articles of manufacture, and methods improve the efficiency of using a computing device by implementing techniques to switch the dynamic range and/or the refresh rate of a display device without including a blank frame in the visual presentation. As such, example techniques disclosed herein can provide a seamless user experience over other switching techniques. Also, because example dynamic range switching techniques and/or example refresh rate switching techniques disclosed herein do not incur the time interval associated with the blank frame presentation, such techniques can perform switching faster and with less power consumption than other switching techniques. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry to provide a graphics output to a display, machine-readable instructions, and at least one processor circuit to be programmed based on the machine-readable instructions to cause the display to activate panel self refresh after a command to switch the graphics output from a first dynamic range to a second dynamic range, switch the graphics output from the first dynamic range to the second dynamic range after the panel self refresh is activated, and cause the display to deactivate the panel self refresh after the graphics output is switched to the second dynamic range.

Example 2 includes the apparatus of example 1, wherein the first dynamic range is a standard dynamic range and the second dynamic range is a high dynamic range that is higher than the standard dynamic range.

Example 3 includes the apparatus of example 1, wherein the first dynamic range is a high dynamic range and the second dynamic range is a standard dynamic range that is lower than the high dynamic range.

Example 4 includes the apparatus of any one of examples 1 to 3, wherein one or more of the at least one processor circuit is to turn the graphics output off after the panel self refresh is activated and the switch of the graphics output from the first dynamic range to the second dynamic range is initiated, the display to present a stored frame while the panel self refresh is activated.

Example 5 includes the apparatus of any one of examples 1 to 4, wherein one or more of the at least one processor circuit is to halt frame updates to the display after the panel self refresh is activated.

Example 6 includes the apparatus of example 5, wherein one or more of the at least one processor circuit is to resume frame updates to the display after the graphics output is switched to the second dynamic range.

Example 7 includes at least one non-transitory computer-readable medium comprising computer-readable instructions to cause at least one processor circuit to at least cause a display to activate panel self refresh after a user input to switch a graphics mode of the display from a first dynamic range to a second dynamic range, switch the graphics mode from the first dynamic range to the second dynamic range after the panel self refresh is activated, and cause the display to deactivate the panel self refresh after the graphics mode is switched to the second dynamic range.

Example 8 includes the at least one non-transitory computer-readable medium of example 7, wherein the first dynamic range is a standard dynamic range and the second dynamic range is a high dynamic range that is higher than the standard dynamic range.

Example 9 includes the at least one non-transitory computer-readable medium of example 7, wherein the first dynamic range is a high dynamic range and the second dynamic range is a standard dynamic range that is lower than the high dynamic range.

Example 10 includes the at least one non-transitory computer-readable medium of any one of examples 7 to 9, wherein the computer-readable instructions are to cause one or more of the at least one processor circuit to switch the graphics mode from the first dynamic range to the second dynamic range without causing the display to present a blank screen or a black screen.

Example 11 includes the at least one non-transitory computer-readable medium of any one of examples 7 to 9, wherein the computer-readable instructions are to cause one or more of the at least one processor circuit to turn off a graphics output to the display after the panel self refresh is activated, the display to present a stored frame while the panel self refresh is activated.

Example 12 includes the at least one non-transitory computer-readable medium of any one of examples 7 to 9, wherein the computer-readable instructions are to cause one or more of the at least one processor circuit to pause frame updates to the display after the panel self refresh is activated.

Example 13 includes the at least one non-transitory computer-readable medium of example 12, wherein the computer-readable instructions are to cause one or more of the at least one processor circuit to resume the frame updates to the display after the graphics mode is switched to the second dynamic range.

Example 14 includes a system comprising means for activating panel self refresh in a display after a user command to switch a graphics mode of the display from a first dynamic range to a second dynamic range, means for switching the graphics mode from the first dynamic range to the second dynamic range after the panel self refresh is activated, and mean for deactivating the panel self refresh in the display after the graphics mode is switched to the second dynamic range.

Example 15 includes the system of example 14, wherein the first dynamic range is a standard dynamic range and the second dynamic range is a high dynamic range that is higher than the standard dynamic range.

Example 16 includes the system of example 14, wherein the first dynamic range is a high dynamic range and the second dynamic range is a standard dynamic range that is lower than the high dynamic range.

Example 17 includes the system of any one of examples 14 to 16, wherein the means for switching is to switch the graphics mode from the first dynamic range to the second dynamic range without causing the display to present a blank screen or a black screen.

Example 18 includes the system of any one of examples 14 to 17, including means for turning off a graphics output to the display after the panel self refresh is activated, the display to present a stored frame while the panel self refresh is activated.

Example 19 includes the system of any one of examples 14 to 18, including means for pausing frame updates to the display after the panel self refresh is activated.

Example 20 includes the system of example 19, including means for resuming the frame updates to the display after the graphics mode is switched to the second dynamic range.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to provide a graphics output to a display;
machine-readable instructions; and
at least one processor circuit to be programmed based on the machine-readable instructions to:
cause the display to activate panel self refresh after a command to switch the graphics output from a first dynamic range to a second dynamic range;
switch the graphics output from the first dynamic range to the second dynamic range after the panel self refresh is activated; and
cause the display to deactivate the panel self refresh after the graphics output is switched to the second dynamic range.

2. The apparatus of claim 1, wherein the first dynamic range is a standard dynamic range and the second dynamic range is a high dynamic range that is higher than the standard dynamic range.

3. The apparatus of claim 1, wherein the first dynamic range is a high dynamic range and the second dynamic range is a standard dynamic range that is lower than the high dynamic range.

4. The apparatus of claim 1, wherein one or more of the at least one processor circuit is to turn the graphics output off after the panel self refresh is activated and the switch of the graphics output from the first dynamic range to the second dynamic range is initiated, the display to present a stored frame while the panel self refresh is activated.

5. The apparatus of claim 1, wherein one or more of the at least one processor circuit is to halt frame updates to the display after the panel self refresh is activated.

6. The apparatus of claim 5, wherein one or more of the at least one processor circuit is to resume frame updates to the display after the graphics output is switched to the second dynamic range.

7. At least one non-transitory computer-readable medium comprising computer-readable instructions to cause at least one processor circuit to at least:
cause a display to activate panel self refresh after a user input to switch a graphics mode of the display from a first dynamic range to a second dynamic range;
switch the graphics mode from the first dynamic range to the second dynamic range after the panel self refresh is activated; and
cause the display to deactivate the panel self refresh after the graphics mode is switched to the second dynamic range.

8. The at least one non-transitory computer-readable medium of claim 7, wherein the first dynamic range is a standard dynamic range and the second dynamic range is a high dynamic range that is higher than the standard dynamic range.

9. The at least one non-transitory computer-readable medium of claim 7, wherein the first dynamic range is a high dynamic range and the second dynamic range is a standard dynamic range that is lower than the high dynamic range.

10. The at least one non-transitory computer-readable medium of claim 7, wherein the computer-readable instructions are to cause one or more of the at least one processor circuit to switch the graphics mode from the first dynamic range to the second dynamic range without causing the display to present a blank screen or a black screen.

11. The at least one non-transitory computer-readable medium of claim 7, wherein the computer-readable instructions are to cause one or more of the at least one processor circuit to turn off a graphics output to the display after the panel self refresh is activated, the display to present a stored frame while the panel self refresh is activated.

12. The at least one non-transitory computer-readable medium of claim 7, wherein the computer-readable instructions are to cause one or more of the at least one processor circuit to pause frame updates to the display after the panel self refresh is activated.

13. The at least one non-transitory computer-readable medium of claim 12, wherein the computer-readable instructions are to cause one or more of the at least one processor circuit to resume the frame updates to the display after the graphics mode is switched to the second dynamic range.

14. A system comprising:
means for activating panel self refresh in a display after a user command to switch a graphics mode of the display from a first dynamic range to a second dynamic range;
means for switching the graphics mode from the first dynamic range to the second dynamic range after the panel self refresh is activated; and
mean for deactivating the panel self refresh in the display after the graphics mode is switched to the second dynamic range.

15. The system of claim 14, wherein the first dynamic range is a standard dynamic range and the second dynamic range is a high dynamic range that is higher than the standard dynamic range.

16. The system of claim 14, wherein the first dynamic range is a high dynamic range and the second dynamic range is a standard dynamic range that is lower than the high dynamic range.

17. The system of claim 14, wherein the means for switching is to switch the graphics mode from the first dynamic range to the second dynamic range without causing the display to present a blank screen or a black screen.

18. The system of claim 14, including means for turning off a graphics output to the display after the panel self refresh is activated, the display to present a stored frame while the panel self refresh is activated.

19. The system of claim 14, including means for pausing frame updates to the display after the panel self refresh is activated.

20. The system of claim 19, including means for resuming the frame updates to the display after the graphics mode is switched to the second dynamic range.
